(19) United States
(12) Patent Application Publication
(10) Pub. No.: US 2003/0185877 A1
(43) Pub. Date: Oct. 2, 2003

(54) Method of producing oily suspensions of water-soluble vitamins

(76) Inventors: Roland Betz, Niederkirchen (DE); Wolfgang Bewert, Frankenthal (DE); Andreas Ernst, Worms (DE); Bruno Kasler, Ludwigshafen (DE); Angelika-Maria Pfieffer, Birkenheide (DE); Frank Runge, Friedelsheim (DE); Joachim U Schneider, Weisenheim (DE); Michael Stang, Ludwigshafen (DE)

Correspondence Address: KEIL & WEINKAUF, 1350 CONNECTICUT AVENUE, N.W., WASHINGTON, DC, 20036, US

(21) Appl. No.: 10/221,203

(22) PCT Filed: Mar. 15, 2001
(86) PCT No.: PCT/EP01/02939

(30) Foreign Application Priority Data
Mar. 17, 2000 (DE) 100 13 312.6
Oct. 4, 2000 (DE) 100 49 137.5

(51) Int. Cl. B02C 23/24; B02C 23/28; A23K 1/165; A23K 1/17

(52) U.S. Cl. 424/442; 241/21

(57) ABSTRACT

The invention relates to a method of producing oily suspensions of water-soluble vitamins which comprises

a) grinding at least one water-soluble vitamin in an oil until the average particle size of from 0.1 to 100 μm, or

b) grinding at least one water-soluble vitamin without using a continuous phase until the average particle size of from 0.1 to 100 μm and subsequently suspending the ground particles in an oil.

The invention relates to oily suspensions of at least one water-soluble vitamin, and to a process for producing these suspensions, and to the use thereof as addition to human foods, animal feeds, pharmaceuticals and cosmetic preparations.

The use of vitamins as feed additives in livestock nutrition takes place more and more in the form of liquid preparations. This has the advantage inter alia that simpler and more accurate dosage is possible. It is moreover possible in the so-called post-pelleting application for example to load a liquid preparation of feed additives onto feed pellets only after they have been produced. The consequence of this is that even oxidation- and temperature-sensitive additives such as vitamins or carotenoids can be employed without major losses.

Examples of post-pelleting application (PPA) are to be found inter alia in GB-A-2 232 573 and in EP-A-0 556 883 and the literature cited therein.

An application which is still critical is the administration of liquid formulations of water-soluble vitamins in combination with minerals and lipid-soluble vitamins. Unwanted losses of active ingredients may occur here through mutual interactions.

EP-A-0 772 978 describes a mixture of such substances in which the vitamins and minerals are stored separately and mixed only shortly before administration. The disadvantage of this procedure is the necessity to provide appropriate storage containers, associated with elaborate logistics.

Vitamin emulsions—as a specific form of a liquid formulation—frequently have the disadvantage that they are physically (occurrence of phase separation) and chemically (occurrence of unwanted hydrolysis and/or redox reactions, chemical incompatibility of individual dissolved components) unstable and, in addition, the risk of microbiological contamination is frequently possible.

Systems in which, inter alia, water-soluble vitamins are dispersed in oils or fats are also known.

Thus, GB-A-1 358 401 describes the production of food supplements based on edible hard fats with melting points of 37 to 121° C. This entails adding finely dispersed assimilable iron-containing substances with stirring to the molten hard fats. The homogeneous dispersion is then spray-cooled to give hard fat pellets. It is also optionally possible to incorporate micronutrients and vitamins. Use in liquid form is possible with the hard fats mentioned herein only at elevated temperature, which is technically complicated and, in the case of the use of vitamins, is frequently associated with the risk of unwanted losses of active ingredients.

It is an object of the present invention to provide stable liquid formulations of water-soluble vitamins which do not have the abovementioned disadvantages of the prior art.

We have found that this object is achieved by a process for producing oily suspensions of water-soluble vitamins, which comprises

a) grinding at least one water-soluble vitamin in an oil, preferably in at least one edible oil, until the average particle size is from 0.1 to 100 μm or

b) grinding at least one water-soluble vitamin without using a continuous phase until the average particle size is from 0.1 to 100 μm and subsequently suspending the ground particles in an oil, preferably in at least one edible oil.

The water-soluble vitamins are, in particular, ascorbic acid and salts thereof, such as sodium ascorbate, and vitamin C derivatives such as sodium, calcium or magnesium ascorbyl-2-monophosphate or calcium ascorbyl-2-polyphosphate, calcium pantothenate, panthenol, vitamin B₁ (thiamine)—as hydrochloride, nitrate or pyrophosphate, vitamin B₂ (riboflavin) and the phosphates thereof, vitamin B₆ and salts, vitamin B₁₂, biotin, folic acid and folic acid derivatives such as tetrahydrofolic acid, 5-methyltetrahydrofolic acid, 5-formyltetrahydrofolic acid, nicotinic acid and nicotinamide.

Another water-soluble vitamin which may be mentioned in this connection is vitamin K₃ (menadione) as sodium bisulfite.

The abovementioned water-soluble vitamins can be employed both in crystalline form with a purity of more than 90%, preferably more than 95%, particularly preferably more than 98%, and in formulated form, for example as granules, beadlet or as spray-dried powder. The abovementioned vitamins in their crystalline form are preferred.

Suitable edible oils are generally all physiologically acceptable oils—of both vegetable and animal origin—especially oils which are liquid at 20° C. or which form the liquid phase in the suspension at 20° C., alone or together with other oils. Mention should preferably be made in this connection of sunflower oil, palm oil, sesame oil, corn oil, cottonseed oil, soybean oil or peanut oil, esters of medium chain-length triglycerides and, in addition, fish oils such as, for example, mackerel, sprat or salmon oil. Particularly preferred for livestock nutrition are fish oils, corn oil, sunflower oil and peanut oil. Additionally advantageous for the food/drugs sector are the esters of medium chain-length triglycerides.

Edible oil also means for the purpose of the invention vitamin E, vitamin E derivatives or mixtures thereof. The term vitamin E stands in this connection for natural or synthetic α-, β-, γ- or δ-tocopherol, preferably for natural or synthetic α-tocopherol and for tocotrienol. Vitamin E derivatives are, for example, tocopheryl C₁-C₂₀-alkanoic esters such as tocopheryl acetate or tocopheryl palmitate.

Vitamin E and/or its derivatives can in this connection be used alone or together with the other edible oils as dispersing medium.

The grinding can take place in a manner known per se, for example using a ball mill. This entails, depending on the type of mill used, grinding until the particles have an average particle size D[4,3] determined by Fraunhofer diffraction of from 0.1 to 100 μm, preferably 0.2 to 50 μm, particularly preferably 0.5 to 30 μm, very particularly preferably 0.8 to 20 μm, in particular 1.0 to 10 μm. The term D[4,3] refers to the volume-weighted average diameter (see handbook for Malvern Mastersizer S, Malvern Instruments Ltd., UK).

Further details of the grinding and the apparatus employed therefor are to be found, inter alia, in Ullmann's Encyclopedia of Industrial Chemistry, Sixth Edition, 1999, Electronic Release, Size Reduction, Chapter 3.6.: Wet Grinding.

It is possible in the grinding process according to the invention to grind all the components from the group of water-soluble vitamins which are used in the suspension as a complete mixture. However, it is also possible to grind each individual component to be ground in high concentration in the oil to be used. The final preparation results by mixing each of the individual suspensions.

Before use, the preparation according to the invention can be diluted with fats or oils to the particular concentration for use.

A particular embodiment of the process according to the invention comprises the grinding in step a) and the grinding and/or suspending in step b) taking place in the absence of an emulsifier. It has surprisingly been found in this connection that it is possible even without the addition of a surfactant to produce fine-particle, homogeneous suspensions of water-soluble vitamins in oils which are stable to sedimentation even in high concentrations.

Another advantageous embodiment of the process according to the invention comprises the grinding in step a) and the grinding and/or suspending in step b) taking place in the absence of a protective colloid.

Despite the absence of the abovementioned dispersing and formulating aid it has been possible—unexpectedly for the skilled worker—for the vitamins which are hydrophilic per se to be ground very finely without wetting problems and agglomeration in the abovementioned hydrophobic dispersing media.

Besides the wet grinding described above, the oily suspensions according to the invention can also be produced by dry grinding of the water-soluble vitamins and subsequent suspension of the ground particles in at least one edible oil. Dry grinding means in this connection a grinding without using a continuous phase.

Further details of dry grinding are to be found, inter alia, in Ullmann's Encyclopedia of Industrial Chemistry, Sixth Edition, 1999, Electronic Release, Size Reduction, Chapter 3.4.

It has proved to be particularly advantageous in relation to the stability of the oily dispersions according to the invention to carry out the grinding in step a) of the process and the grinding and/or suspending in step b) in the presence of desiccants. Desiccants preferred in this connection are selected from the group consisting of alkali metal and alkaline earth metal sulfates such as sodium, calcium and magnesium sulfates, alkali etal and alkaline earth metal chlorides such as sodium, calcium and magnesium chlorides, and silica gel. CaCl₂ should be mentioned as very particularly preferred desiccant.

The amount of desiccant employed is generally between 0.1 and 20% by weight, preferably between 0.5 and 15% by weight, particularly preferably between 1.0 and 10% by weight, based on the total amount of the oily suspension.

The desiccant(s) used may moreover be ground separately—as in step a) of the process—in an edible oil and subsequently added to the oily suspension of the ground water-soluble vitamins. A further possibility is also to mix the desiccant unground with the oily suspension of the ground water-soluble vitamins from step a) of the process. In the case of dry grinding, the water-soluble vitamins and the desiccant(s) can also be ground separately and then be added to the oily suspension.

Because the dispersed water-soluble vitamins are finely dispersed, the oily suspensions produced by the process according to the invention are distinguished by high bioavailability of the active ingredients present in the suspension.

Besides the water-soluble vitamins mentioned at the outset, it is possible for additional lipid-soluble vitamins such as, for example, the K vitamins, vitamin A and derivatives such as vitamin A acetate, vitamin A propionate or vitamin A palmitate, vitamin D₂ and vitamin D₃, and the aforementioned E vitamins, to be introduced and dissolved in the oily suspension before, during or after the grinding. The grinding in step a) and the suspending in step b) preferably take place in the presence of lipid-soluble vitamins.

The invention also relates to oily suspensions of at least one water-soluble vitamin obtainable by a process wherein at least one water-soluble vitamin is ground in at least one edible oil until the average particle size is from 0.1 to 100 μm.

The oily suspensions according to the invention comprise from 5 to 70% by weight, preferably 5 to 60% by weight, particularly preferably 10 to 55% by weight, very particularly preferably 15 to 50% by weight, of at least one of the water-soluble vitamins mentioned at the outset in very finely ground form.

In addition, the oily suspensions may additionally comprise from 0.5 to 60% by weight, preferably 5 to 50% by weight, particularly preferably 10 to 45% by weight, very particularly preferably 15 to 40% by weight, of at least one of the lipid-soluble vitamins mentioned at the outset in dissolved form.

The oily preparations may moreover additionally comprise at least one other carotenoid.

Carotenoids mean, for example, the following compounds: β-carotene, lycopene, lutein, astaxanthin, zeaxanthin, cryptoxanthin, citranaxanthin, canthaxanthin, bixin, β-apo-4-carotenal, β-apo-8-carotenal, β-apo-8-carotenoic esters, singly or as mixtures. Carotenoids preferably used are β-carotene, lycopene, lutein, astaxanthin, zeaxanthin, citranaxanthin and canthaxanthin.

The carotenoids can be employed for this purpose in crystalline form or as formulation—for example as dry powder as disclosed in EP-A-0 065 193.

It is advantageous for the carotenoids usually to be ground in crystalline form together with the water-soluble vitamins in the oil. In the case of astaxanthin and canthaxanthin it is preferred to employ astaxanthin- and canthaxanthin-containing dry powders, for example Lucantin® Pink and Lucantin® Red (respectively 10% astaxanthin and canthaxanthin dry powders supplied by BASF Aktiengesellschaft, Ludwigshafen, Germany) together with the water-soluble vitamins.

The carotenoid content in the formulations is generally between 0.1 and 40% by weight, preferably between 0.3 and 20% by weight, particularly preferably between 0.5 and 10% by weight, very particularly preferably between 1 and 5% by weight, based on the total amount of the formulation.

Depending on the purpose for which the oily preparations according to the invention are used they may contain up to 10% by weight of other additional components such as, for example, minerals, amino acids, proteins or enzymes.

These additives can, just like the abovementioned lipid-soluble vitamins and carotenoids, be added to the suspension according to the invention before, during or after the grinding. In order to obtain a homogeneous suspension, with the finest possible particles, of all the non-oil-soluble ingredients, it is advantageous to grind the abovementioned additives likewise together with the water-soluble vitamins.

Minerals which can be incorporated into and ground along with the suspension are, for example, iron sulfate, zinc sulfate, manganese sulfate, copper sulfate, calcium sulfate, sodium sulfate, copper oxide, magnesium oxide, calcium fluoride, potassium chloride, potassium iodide, sodium chloride, calcium iodate, calcium, magnesium, potassium, sodium or iron phosphate, cobalt carbonate, sodium selenate or silica and salts thereof. The amount of minerals employed, for example in the livestock nutrition sector, depends in each case on the requirement of the stock to be fed.

Suitable amino acid residues are in general all known physiologically acceptable α-amino acid residues. Residues of the following amino acids should be mentioned preferably: alanine, arginine, asparagine, aspartic acid, cysteine, cystine, glutamine, glutamic acid, glycine, histidine, isoleucine, leucine, lysine, methionine, phenylalanine, hippuric acid, serine and taurine. Lysine, methionine and cysteine are particularly preferred.

Suitable enzymes in this connection are preferably phosphatases, glucanases and, where appropriate, esterases and lipases, the latter in encapsulated form.

Further ingredients of the suspension may be:

Compounds with vitamin or coenzyme characteristics, for example choline chloride, carnitine, γ-butyrobetaine, lipoic acid, creatine, ubiquinones, S-methylmethionine, S-adenosylmethionine.

Polyunsaturated fatty acids, for example linoleic acid, linolenic acid, arachidonic acid, eicosapentaenoic acid, docosahexaenoic acid.

Feed antibiotics for medicated feeds, and microorganisms to improve digestion.

It may be necessary in some cases for the oily suspensions additionally to contain excipients such as, for example, protective colloids, antioxidants, thickeners, chelating agents such as, for example, alkali metal or alkaline earth metal salts of citric acid, phytic acid or phosphoric acid and/or to contain emulsifiers.

Protective colloids which can be used are, for example, gelatin, fish gelatin, starch, dextrin, vegetable proteins, pectin, gum arabic, casein, caseinate or mixtures thereof. However, it is also possible to employ polyvinyl alcohol, polvinylpyrrolidone, methylcellulose, carboxymethylcellulose, hydroxypropylcellulose and alginates. For further details, reference is made to R. A. Morton, Fat Soluble Vitamins, Intern. Encyclopedia of Food and Nutrition, vol.9, Pergamon Press 1970, p. 128-131.

To increase the stability of the active ingredient to oxidative breakdown it is advantageous to add stabilizers such as α-tocopherol, t-butylhydroxytoluene, t-butylhydroxyanisole, ascorbic acid or ethoxyquin.

Emulsifiers and solubilizers which can be used are, for example, ascorbyl palmitate, polyglycerol fatty acid esters, sorbitan fatty acid esters, propylene glycol fatty acid esters or lecithin.

The oily suspensions according to the invention have the advantage inter alia that the vitamins are protected from oxygen and moisture by the oil. The water-soluble vitamins and the minerals are virtually insoluble in oils and thus cannot undergo any reactions with one another (compatibility). In addition, microbiological problems are not to be expected in oily, anhydrous systems.

The suspensions are suitable inter alia as additives to human food and animal feed preparations and compound feeds, as compositions for producing pharmaceutical and cosmetic preparations, and for producing supplement products for human and animal foods.

It is possible and preferred to employ the suspensions as feed additive in livestock nutrition, in particular for applying to or spraying onto feed pellets.

The use as feed additive takes place in particular by directly spraying the suspensions according to the invention, where appropriate after dilution with oils, for example onto animal feed pellets as so-called post-pelleting application.

A preferred embodiment of the spraying process consists in loading the feed pellets with the oily suspension under reduced pressure.

Examples thereof are to be found inter alia in GB-A-2 232 573 and in EP-A-0 556 883.

Typical areas of use in the human food sector are, for example, the vitaminization of beverages, dairy products such as yoghurt, milk drinks or milk ice, and blancmange powders, egg products, baking mixes and confectionery.

In the cosmetics sector, the oily suspensions can be used, for example, for vitamin-containing body-care compositions, for example in the form of a cream, a lotion, as lipsticks or makeup.

The oil phase of the suspensions of the present invention used for cosmetic purposes is advantageously chosen from the group of esters of saturated and/or unsaturated, branched and/or unbranched alkanecarboxylic acids of chain length from 3 to 30 carbon atoms, from the group of esters of aromatic carboxylic acids and saturated and/or unsaturated, branched and/or unbranched alcohols of chain length from 3 to 30 carbon atoms. Such ester oils can then advantageously be chosen from the group consisting of isopropyl myristate, isopropyl palmitate, isopropyl stearate, isopropyl oleate, n-butyl stearate, n-hexyl laurate, n-decyl oleate, isooctyl stearate, isononyl stearate, isononyl isononanoate, 2-ethylhexyl palmitate, 2-ethylhexyl laurate, 2-hexyldecyl stearate, 2-octyldodecyl palmitate, oleyl oleate, oleyl erucate, erucyl oleate, erucyl erucate, and synthetic, semisynthetic and natural mixtures of such esters, e.g. jojoba oil.

The oil phase can furthermore advantageously be chosen from the group of branched and unbranched hydrocarbons and hydrocarbon waxes, silicone oils, dialkyl ethers, the group of saturated or unsaturated, branched or unbranched alcohols, and the fatty acid triglycerides, namely the triglycerol esters of saturated and/or unsaturated, branched and/or unbranched alkanecarboxylic acids of chain length from 8 to 24, in particular 12 to 18, carbon atoms. The fatty acid triglycerides can, for example, be advantageously chosen from the group of synthetic, semisynthetic and natural oils, e.g. olive oil, sunflower oil, soybean oil, groundnut oil, rapeseed oil, almond oil, palm oil, coconut oil, palm kernel oil and the like.

Also, any mixtures of such oil and wax components can be advantageously used for the purposes of the present invention. It may also be advantageous in some instances to use waxes, for example cetyl palmitate, as the sole lipid component of the oil phase.

The oil phase is advantageously chosen from the group consisting of 2-ethylhexyl isostearate, octyldodecanol, isotridecyl isononanoate, isoeicosane, 2-ethylhexyl cocoate, C₁₂₋₁₅-alkylbenzoate, caprylic/capric triglyceride, dicaprylic ether.

Particularly advantageous mixtures comprise C₁₂₋₁₅-alkyl benzoate, 2-ethylhexyl isostearate and isotridecyl isononanoate.

Of the hydrocarbons, paraffin oil, squalane and squalene are advantageous for the purposes of the present invention.

The oil phase can further advantageously have a content of cyclic or linear silicone oils or consist entirely of such oils, although it is preferred, apart from the silicone oil or silicone oils, to use an additional content of other oil phase components.

Cyclomethicone (octamethylcyclotetrasiloxane) is advantageously used as the silicone oil to be used according to the invention. However, other silicone oils are also advantageous for the purposes of the present invention, for example, hexamethylcyclotrisiloxane, polydimethylsiloxane, poly(methylphenylsiloxane).

Other particularly advantageous mixtures comprise cyclomethicone and isotridecyl isononanoate, or cyclomethicone and 2-ethylhexyl isostearate.

The invention further relates to food supplements, animal feeds, human foods and pharmaceutical and cosmetic preparations comprising the oily suspensions of water-soluble vitamins described at the outset.

In the case of pharmaceutical preparations, the oily suspensions may comprise the following active ingredients or additional component—singly or in a mixture:

analgesics such as acetylsalicylic acid, ibuprofen, flurbiprofen, paracetamol, propyphenazone,

sympathomimetics such as pseudoephedrine, ephedrine, phenylpropanolamine, phenylephrine,

antihistamines such as chlorpheniramine maleate,

antitussives such as dihydrocodeine, guaifenesine,

plant extracts such as hawthorn extract, bearberry leaf extract, juniper berry extract, ginseng extract,

caffeine.

The invention is preferably directed to animal feeds, in particular feed pellets, loaded with the suspensions.

Food supplement products and pharmaceutical preparations comprising the suspension according to the invention mean, inter alia, uncoated and coated tablets and, preferably, hard and soft gelatin capsules.

Cosmetic preparations which may comprise the suspensions according to the invention are, for example, preparations which can be applied topically, in particular decorative body-care compositions such as lipsticks, facial makeup in the form of a cream, and lotions.

Production of the oily suspensions of water-soluble vitamins according to the invention is explained in detail in the following examples.

### EXAMPLE 1

Two kilograms of a mixture of 25% by weight of vitamin C (99% pure, BASF Aktiengesellschaft) and 75% by weight of a medium chain-length triglyceride (Delios® SK supplied by Grünau, Germany) were stirred with a paddle stirrer until a homogeneous suspension was obtained. The mixture was then transferred into a stirrable receiver from which the suspension was conveyed by means of a roller pump through a continuously operated ball mill (Dyno Mill KDL Special). The grinding container of the ball mill was packed with 400 g of glass beads (diameter 800 to 1200 μm). The fine-particle suspension emerging from the mill was collected and measured using a particle sizer (Malvern Mastersizer). The grinding process was repeated until 90% of the suspended particles were less than 10 μm in size [D(0.9)<10 μm]. This corresponded to an average particle size D[4,3] of 5.2 μm.

After separation from the grinding beads, part of the dispersion was diluted with 10 times the amount of the oil used and was left to stand for 12 h. There were no signs of sedimentation either by the undiluted or by the diluted dispersion during this period.

### EXAMPLE 2

A mixture of

| Component | Amount in g |
|---|---|
| Vitamin C | 200 |
| Calcium d-pantothenate | 140 |
| Nicotinic acid | 280 |
| Folic acid | 4.0 |
| Biotin | 2.0 |
| Vitamin B₁₂ | 0.1 |
| Vitamin B₆ HCl | 20 |
| Vitamin B₂ | 100 |
| Vitamin B₁ HCl | 40 |
| Vitamin K₃ (menadione Na bisulfite) | 40 |
| Vitamin E acetate | 400 |
| Vitamin D₃ | 0.10 |
| Vitamin A acetate | 8.2 |
| D,l-α-Tocopherol | 600 |

was stirred with a paddle stirrer until a homogeneous suspension was obtained. The mixture was then transferred into a stirrable receiver from which the suspension was conveyed by means of a roller pump through the continuously operated ball mill mentioned in Example 1. The grinding process was repeated until 90% of the suspended particles were less than 20 μm in size [D(0.9)<20 μm]. This corresponded to an average particle size D[4,3] of 10.9 μm.

After separation from the grinding beads, part of the dispersion was diluted with 10 times the amount of corn oil and left to stand for 12 h. There were no signs of sedimentation either by the undiluted or by the diluted dispersion during this period.

### EXAMPLE 3

| Component | Amount in g |
|---|---|
| Vitamin C | 400 |
| Calcium d-pantothenate | 140 |
| Nicotinic acid | 280 |
| Folic acid | 4.0 |
| Lutavit ® H₂ (2% biotin, supplied by BASF) | 100 |
| Vitamin B₁₂ | 0.1 |
| Vitamin B₆ HCl | 20 |
| Vitamin B₂ | 100 |
| Vitamin B₁ HCl | 40 |
| Vitamin K₃ (menadione Na bisulfite) | 20 |
| Vitamin E acetate | 400 |
| Vitamin D₃ | 0.10 |
| Vitamin A acetate | 8.2 |
| Corn oil | 800 |

was suspended and ground by a continuously operated ball mill in analogy to Example 2. The grinding process was continued until 90% of the suspended particles were less than 30 μm in size [D(0.9)<30 μm]. This corresponded to an average particle size D[4,3] of 15.3 μm.

After separation from the grinding beads, part of the dispersion was diluted with 10 times the amount of corn oil and left to stand for 12 h. There were no signs of sedimentation either by the undiluted or by the diluted dispersion during this period.

### EXAMPLE 4

In analogy to Example 2, a mixture of

| Component | Amount in g |
|---|---|
| Calcium d-pantothenate | 88 |
| Nicotinic acid | 320 |
| Folic acid | 2.4 |
| Biotin | 16 |
| Vitamin B₁₂ | 0.3 |
| Vitamin B₆ HCl | 32 |
| Vitamin B₂ | 50 |
| Vitamin B₁ HCl | 24 |
| Vitamin K₃ (menadione Na bisulfite) | 8 |
| Vitamin E acetate | 480 |
| Vitamin D₃ | 0.2 |
| Vitamin A acetate | 30 |
| Corn oil | 600 |

was suspended and ground by a continuously operated ball mill. The grinding process was continued until 90% of the suspended particles were less than 20 μm in size [D(0.9)<20 μm]. This corresponded to an average particle size D[4,3] of 10.9 μm.

After separation from the grinding beads, part of the dispersion was diluted with 10 times the amount of corn oil and left to stand for 12 h. There were no signs of sedimentation either by the undiluted or by the diluted dispersion during this period.

### EXAMPLE 5

In analogy to Example 2, a mixture of

| Component | Amount in g |
|---|---|
| Vitamin C | 400 |
| Calcium d-pantothenate | 88 |
| Nicotinic acid | 320 |
| Folic acid | 2.4 |
| Biotin | 1.6 |
| Vitamin B₁₂ | 0.3 |
| Vitamin B₆ HCl | 32 |
| Vitamin B₂ | 50 |
| Vitamin B₁ HCl | 24 |
| Vitamin K₃ (menadione Na bisulfite) | 8 |
| Sunflower oil | 1000 |

was suspended and ground by a continuously operated ball mill. The grinding process was continued until 90% of the suspended particles were less than 20 μm in size [D(0.9)<20 μm]. This corresponded to an average particle size D[4,3] of 10.9 μm.

After separation from the grinding beads, part of the dispersion was diluted with 10 times the amount of sunflower oil and left to stand for 12 h. There were no signs of sedimentation either by the undiluted or by the diluted dispersion during this period.

### EXAMPLE 6

In analogy to Example 2, a mixture of

| Component | Amount in g |
|---|---|
| Vitamin C | 400 |
| Calcium d-pantothenate | 88 |
| Nicotinic acid | 320 |
| Folic acid | 2.4 |
| Biotin | 1.6 |
| Vitamin B₁₂ | 0.3 |
| Vitamin B₆ HCl | 32 |
| Vitamin B₂ | 50 |
| Vitamin B₁ HCl | 24 |
| Vitamin K₃ (menadione Na bisulfite) | 8 |
| Fish oil | 1000 |

was suspended and ground by a continuously operated ball mill. The grinding process was continued until 90% of the suspended particles were less than 20 μm in size [D(0.9)<20 μm]. This corresponded to an average particle size D[4,3] of 10.9 μm.

After separation from the grinding beads, part of the dispersion was diluted with 10 times the amount of fish oil and left to stand for 12 h. There were no signs of sedimentation either by the undiluted or by the diluted dispersion during this period.

### EXAMPLE 7

In analogy to Example 2, a mixture of

| Component | Amount in g |
|---|---|
| Vitamin C | 200 |
| Calcium d-pantothenate | 140 |
| Nicotinamide | 280 |
| Folic acid | 4.0 |
| Biotin | 2.0 |
| Vitamin B₁₂ | 0.1 |
| Vitamin B₆ HCl | 20 |
| Vitamin B₂ | 100 |
| Vitamin B₁ HCl | 40 |
| Vitamin K₃ (menadione Na bisulfite) | 20 |
| Vitamin E acetate | 400 |
| Vitamin D₃ | 0.10 |
| Vitamin A acetate | 8.2 |
| D,l-α-tocopherol | 600 |

was suspended and ground by a continuously operated ball mill. The grinding process was continued until 90% of the suspended particles were less than 20 μm in size [D(0.9)<20 μm]. This corresponded to an average particle size D[4,3] of 10.9 μm.

After separation from the grinding beads, part of the dispersion was diluted with 10 times the amount of corn oil and left to stand for 12 h. There were no signs of sedimentation either by the undiluted or by the diluted dispersion during this period.

### EXAMPLE 8

In analogy to Example 2, a mixture of

| Component | Amount in g |
|---|---|
| Vitamin C | 100 |
| Lucantin ® Pink (10% astaxanthin dry powder | 500 |
| supplied by BASF) | |
| Vitamin K₃ (menadione Na bisulfite) | 5 |
| Vitamin B₁ nitrate | 15 |
| Vitamin A acetate | 5.0 |
| Vitamin E acetate | 50 |
| Ethoxyquin | 0.1 |
| Fish oil | 1000 |

was suspended and ground by a continuously operated ball mill. The grinding process was continued until 90% of the suspended particles were less than 20 μm in size [D(0.9)<20 μm].

After separation from the grinding beads, part of the dispersion was diluted with 10 times the amount of fish oil and left to stand for 12 h. There were no signs of sedimentation either by the undiluted or by the diluted dispersion during this period.

### EXAMPLE 9

In analogy to Example 2, a mixture of

| Component | Amount in g |
|---|---|
| Vitamin C | 200 |
| β-Carotene (cryst.) | 10 |
| Calcium d-pantothenate | 140 |
| Nicotinamide | 280 |
| Folic acid | 4.0 |
| Biotin | 2.0 |
| Vitamin B₁₂ | 0.1 |
| Vitamin B₆ HCl | 20 |
| Vitamin B₂ | 100 |
| Vitamin B₁ HCl | 40 |
| Vitamin K₃ (menadione Na bisulfite) | 20 |
| Vitamin E acetate | 400 |
| Vitamin D₃ | 0.10 |
| Vitamin A acetate | 8.2 |
| D,l-α-Tocopherol | 600 |

was suspended and ground by a continuously operated ball mill. The grinding process was continued until 90% of the suspended particles were less than 20 μm in size [D(0.9)<20 μm].

After separation from the grinding beads, part of the dispersion was diluted with 10 times the amount of corn oil and left to stand for 12 h. There were no signs of sedimentation either by the undiluted or by the diluted dispersion during this period.

### EXAMPLE 10

In analogy to Example 4, a mixture of

| Component | Amount in g |
|---|---|
| Calcium d-pantothenate | 88 |
| Nicotinic acid | 320 |
| Folic acid | 2.4 |
| Biotin | 16 |
| Vitamin B₁₂ | 0.3 |
| Vitamin B₆ HCl | 32 |
| Vitamin B₂ | 50 |
| Vitamin B₁ HCl | 24 |
| Vitamin K₃ (menadione Na bisulfite) | 8 |
| Vitamin E acetate | 480 |
| Vitamin D₃ | 0.2 |
| Vitamin A acetate | 30 |
| CaCl₂ (anhydrous) | 100 |
| Corn oil | 600 |

was suspended and ground by a continuously operated ball mill. The grinding process was continued until 90% of the suspended particles were less than 20 μm in size [D(0.9)<20 μm]. This corresponded to an average particle size D[4,3] of 10.9 μm.

After separation from the grinding beads, part of the dispersion was diluted with 10 times the amount of corn oil and stood at 40° C. over a period of one month. There were no signs of sedimentation either by the undiluted or by the diluted dispersion during this period.

1. A process for producing oily suspensions of water-soluble vitamins, which comprises
a) grinding at least one water-soluble vitamin in an oil until the average particle size is from 0.1 to 100 μm or
b) grinding at least one water-soluble vitamin without using a continuous phase until the average particle size is from 0.1 to 100 μm and subsequently suspending the ground particles in an oil.

2. A process as claimed in claim 1, wherein the oil is at least one edible oil.

3. A process as claimed in either of claims 1 and 2, wherein the oil is an oil which is liquid at 20° C.

4. A process as claimed in either of claims 2 and 3, wherein vitamin E, vitamin E derivatives or mixtures thereof are used as edible oil.

5. A process as claimed in any of claims 1 to 4, wherein the grinding in step a) and the grinding and/or suspending in step b) take place in the absence of an emulsifier.

6. A process as claimed in any of claims 1 to 5, wherein the grinding in step a) and the grinding and/or suspending in step b) take place in the absence of a protective colloid.

7. A process as claimed in any of claims 1 to 6, wherein at least one of the water-soluble vitamins is employed in crystalline form.

8. A process as claimed in any of claims 1 to 7, wherein the grinding in step a) and the suspending in step b) take place in the presence of lipid-soluble vitamins.

9. A process as claimed in any of claims 1 to 8, wherein the grinding in step a) and the grinding and/or suspending in step b) take place in the presence of desiccants.

10. A process as claimed in claim 9, wherein substances selected from the group consisting of alkali metal and alkaline earth metal sulfates, alkali metal and alkaline earth metal chlorides and silica gel are used as desiccants.

11. An oily suspension of at least one water-soluble vitamin obtainable by a process as defined in any of claims 1 to 10.

12. An oily suspension as claimed in claim 11, comprising from 5 to 70% by weight of at least one water-soluble vitamin.

13. An oily suspension as claimed in either of claims 11 and 12, additionally comprising from 0.5 to 60% by weight of at least one lipid-soluble vitamin.

14. The use of the oily suspensions as defined in any of claims 11 to 13 as addition to human foods and animal feeds, pharmaceuticals and cosmetic preparations.

15. The use as claimed in claim 14 as feed additive in livestock nutrition.

16. The use as claimed in claim 15 for application to feed pellets.

17. The use as claimed in claim 16, wherein the feed pellets are loaded with the oily suspension under reduced pressure.

18. Feed pellets comprising oily suspensions as defined in any of claims 11 to 13.
